(19) United States
(12) Patent Application Publication
(10) Pub. No.: US 2011/0144264 A1
(43) Pub. Date: Jun. 16, 2011

(54) PROCESS FOR PREPARING STABILIZED LATICES BY EMULSION POLYMERIZATION

(75) Inventor: Manuel Hidalgo, Brignais (FR)

(73) Assignee: Coatex

(21) Appl. No.: 12/161,447

(22) PCT Filed: Jan. 9, 2007
(86) PCT No.: PCT/FR2007/050630

§ 371 Date: Mar. 1, 2011

(30) Foreign Application Priority Data
Jan. 18, 2006 (FR) 0600439

(51) Int. Cl. C08L 33/14

(52) U.S. Cl. 524/533

(57) ABSTRACT

The invention relates to the use of poly(ethylene-co-propylene) glycol monoalkyl ether or polyethylene glycol monoalkyl ether or poly(ethylene-co-propylene) glycol or polyethylene glycol (meth)acrylic amide or ester monomers capable of contributing to stabilization in the course of a latex preparation process by emulsion polymerization of at least one polymerizable monomer in the presence of an ionizable polymerization initiator.

### TECHNICAL FIELD

The invention relates to the stabilization of latices obtained by emulsion polymerization, and more particularly to the use of (meth)acrylic monomers of the type such as polyethylene glycol or poly(ethylene-co-propylene) glycol or polyethylene glycol monoalkyl ether or poly(ethylene-co-propylene) glycol monoalkyl ether (meth)acrylic esters or amides, which are capable of contributing toward the stabilization during a process for the preparation of latices by emulsion polymerization of at least one polymerizable monomer.

The term “latices” means colloidal dispersions of predominantly hydrophobic particles of polymers, more particularly aqueous dispersions of polymer particles as are obtained by emulsion polymerization.

The term “(meth)acrylic ester or amide” means an ester or amide of acrylic acid or of methacrylic acid.

In the context of the invention, the term “emulsion polymerization” means, besides standard emulsion polymerization, also related synthetic methods, such as mini-emulsion and micro-emulsion polymerization, insofar as these techniques also make use of surfactants. These various techniques are described in reference works on emulsion polymerization, for instance the publication El-Aasser, M. S. & Lovell, P. A., editors, Emulsion Polymerization, and Emulsion Polymers, John Wiley & Sons, 1997.

These stabilized latices find applications in many fields of use, such as those of materials (PS, PMMA, PVC, elastomers), paints and varnishes, binders and fiber treatments for paper and textile, adhesives, and additives for concrete, bitumens or plastics.

### PRIOR ART

Document EP 095 263 describes a process for manufacturing aqueous polymer dispersions with exclusively steric stabilization, using, on the one hand, a nonionizable azo polymerization initiator that is soluble in the aqueous phase, and, on the other hand, a stabilizer which is a block or grafted copolymer containing a polymeric component that can be solvated by the aqueous phase and a polymeric component of another type that cannot be solvated by the aqueous phase. This stabilizer may be obtained in situ via a copolymerization reaction with the monomers of the dispersion. The use of uncharged initiators is an indissociable characteristic of the process, since it is a matter of obtaining dispersions that are exclusively sterically stabilized, and thus a nonionic system, without any charge originating from the stabilizer or the polymerization initiator.

Document U.S. Pat. No. 4,385,164 describes the preparation of dispersion stabilizers constituted by block copolymers comprising a hydrophilic block and a hydrophobic block with side groups containing reactive functionality, for instance epoxy groups or ethylenic unsaturations. Document U.S. Pat. No. 4,385,164 also describes a process for polymerizing an ethylenically unsaturated monomer in water in the presence of a dispersion stabilizer as prepared beforehand.

Patent application WO 01/74736 describes a process for preparing dispersing polymers for mineral fillers such as cement, by solution polymerization of acrylic derivatives. This process allows the preparation of aqueous solutions containing a high concentration of acrylic copolymer.

Document FR 2 851 937 concerns an aqueous solution polymerization of a mixture of (meth)acrylic monomers. The use of a system for controlling the molecular masses that intervenes simultaneously during the initiation and radical-transfer steps allows the preparation of a water-soluble dispersant with a controlled molecular mass distribution and having improved properties.

In document FR 2 360 646, a resin dispersion is obtained by polymerizing an ethylenically unsaturated monomer capable of forming a polymer that is insoluble in aqueous medium, in an aqueous solution containing a water-soluble polymer derived from acrylic monomers. Stabilization of the dispersion is achieved by the presence of this water-soluble acrylic polymer, obtained beforehand via a solution polymerization step.

### DESCRIPTION OF THE INVENTION

The process for preparing a stabilized latex, by emulsion polymerization of at least one polymerizable monomer according to the invention, is performed in the presence of a water-soluble polymerization initiator and of at least one emulsifier, characterized in that an ionizable water-soluble polymerization initiator is used and in that the emulsifier is at least partially replaced with stabilizing polymer molecules formed in situ by introduction of at least one (meth)acrylic monomer of the type such as a polyethylene glycol or poly(ethylene-co-propylene) glycol or polyethylene glycol monoalkyl ether or poly(ethylene-co-propylene) glycol monoalkyl ether (meth)acrylic ester or amide, in which the alkyl group contains from 1 to 18 carbon atoms and preferably from 1 to 4 carbon atoms, during at least one of the emulsion polymerization steps.

The polymerization medium comprises a liquid organic phase and a liquid aqueous phase, said liquid organic phase preferably comprising more than 50% by weight of monomer(s) to be polymerized and said aqueous phase preferably comprising at least 50% by weight of water. The polymerization initiator is generally soluble in the aqueous phase (which is the case for standard emulsion polymerization).

Without the Applicant wishing to be bound by any explanation, it is thought that the stabilization of the latex in the process according to the invention takes place via:
the ionic groups originating from the ionizable polymerization initiator (electrostatic stabilization)
the conventional emulsifier present in the polymerization medium, i.e. a surfactant allowing the emulsion to be stabilized by steric and/or electrostatic stabilization
the stabilizing polymer molecules involving said polyethylene glycol or poly(ethylene-co-propylene) glycol or polyethylene glycol monoalkyl ether or poly(ethylene-co-propylene) glycol monoalkyl ether (meth)acrylic ester or amide monomers, obtained in situ in the polymerization medium (steric stabilization).

The introduction of a (meth)acrylic monomer of the invention during at least one of the emulsion polymerization steps allows the copolymerization between said monomer and one or more other polymerizable monomers of the emulsion system to be polymerized. This copolymerization contributes toward anchoring the stabilizing polymer molecules thus obtained at the surface of the colloidal particles of the latex. It also contributes toward developing the amphiphilic nature of these stabilizing polymer molecules obtained, on the one hand, from the hydrophilic constituent units of the polyethylene glycol or poly(ethylene-co-propylene) glycol or polyethylene glycol monoalkyl ether or poly(ethylene-co-propylene) glycol monoalkyl ether (meth)acrylic ester or amide monomers, and, on the other hand, of the more hydrophobic monomers of the system to be polymerized itself. In the structure of the stabilizing polymer molecules of the invention, the hydrophobic units are not distributed in the form of blocks, and originate directly from the monomer units of the system to be emulsion polymerized. The surface anchoring and the development of the amphiphilic nature of these stabilizing polymer molecules in fact afford an improved stabilizing effect when compared with that obtained with standard emulsifiers.

Other characteristics and advantages of the invention will emerge more clearly on reading the description that follows.

### DETAILED DESCRIPTION OF THE INVENTION

The (meth)acrylic monomer of the invention may be introduced into the polymerization medium to a proportion of from 0.05% to 30% and preferably from 0.1% to 10% by mass relative to the mass of monomer(s). It may be introduced as a mixture with the monomers of the system to be polymerized or separately. It may be introduced in a single portion at a given moment in the emulsion polymerization, which may be the start (conversion of the monomers into polymer equal to 0), or another moment in the polymerization other than the start (conversion of the monomers into polymer greater than zero). It may be introduced in several portions via batch additions at different moments (different degrees of conversion of the monomers into polymer) in the emulsion polymerization. Finally, it may be introduced via continuous addition, over a given time that may cover the entire reaction time (polymerization time), or only a portion of the reaction time. Preferably, the methacrylic monomer of the invention is introduced as a mixture with the monomers to be polymerized, for example according to the common practice that consists in introducing at least part of the monomers to be polymerized in the form of an aqueous emulsion comprising water, monomers and surfactants (the “pre-emulsion”). Said pre-emulsion is often added continuously into a reactor over a given time that may cover the entire polymerization time. The (meth)acrylic monomer of the invention may advantageously replace all or part of the conventional surfactant used to stabilize said pre-emulsion.

The (meth)acrylic monomer is a polyethylene glycol or poly(ethylene-co-propylene) glycol or polyethylene glycol monoalkyl ether or poly(ethylene-co-propylene) glycol monoalkyl ether (meth)acrylic ester or amide, in which the alkyl group contains from 1 to 18 carbon atoms and preferably from 1 to 4 carbon atoms. In general, these (meth)acrylic esters or amides may be prepared from the corresponding alcohols (polyethylene glycol or poly(ethylene-co-propylene) glycol or polyethylene glycol monoalkyl ether or poly(ethylene-co-propylene) glycol monoalkyl ether), via a direct esterification reaction with the (meth)acrylic acid, or direct amidation with the acrylamide or the methacrylamide, or else by reaction with the (meth)acrylic anhydride or with the (meth)acrylic acid halide. They may also be prepared via a transesterification or transamidation reaction starting with (meth)acrylic esters or amides such as, for example, alkyl (meth)acrylates. Finally, they may be prepared by alkoxylation of a (meth)acrylic ester or amide monomer comprising an alcohol function, for instance hydroxyethyl (meth)acrylate.

An example of preparation of (meth)acrylic monomers that are useful for the invention is described in the international patent application published under the number WO 01/74736. These monomers are, furthermore, commercially available.

More particularly, the (meth)acrylic ester or amide of the invention has a number-average molecular mass of at least 750 daltons, preferably ranging from 1000 to 10 000 daltons. Preferably, the (meth)acrylic monomer is a methoxy polyethylene glycol methacrylate (MPEGMA), and more particularly a methoxy polyethylene glycol methacrylate with a number-average molecular mass of at least 1000 daltons, preferably ranging from 1000 to 6000 daltons.

In one of the preferred forms of the invention, the (meth)acrylic monomer contains (meth)acrylic acid as impurity, or is supplemented with an unsaturated carboxylic acid such as (meth)acrylic acid in proportions that may be up to 20% by weight and preferably between 2% and 10% by weight relative to the (meth)acrylic monomer. This has the effect of promoting the steric/electrostatic combined stabilization of the latex, since the unsaturated carboxylic acid units, once copolymerized with the monomers of the emulsion, also afford ionic stability.

The emulsifier present in the polymerization medium is a conventional emulsifier, which may be an anionic, cationic or nonionic surfactant. The conventional emulsifier may also be an amphoteric or quaternary or fluoro surfactant. It may also be constituted by a mixture of products derived from the preceding categories. Examples of emulsifiers that may be used include alkyl or aryl sulfates, alkyl or aryl sulfonates, fatty acid salts, polyvinyl alcohols, polyethoxylated fatty alcohols, polyethoxylated alkylphenols, polysaccharide derivatives and sorbitan derivatives. By way of example, the emulsifier may be sodium lauryl sulfate, sodium dodecylbenzenesulfonate, sodium stearate, a polyethoxylated nonylphenol, sodium dihexylsulfosuccinate, sodium dioctylsulfosuccinate, lauryldimethylammonium bromide, laurylamidobetaine, potassium perfluorooctylacetate, or a mixture of alkanesulfonates.

The conventional emulsifier may also be a block, random or grafted amphiphilic copolymer, for instance copolymers of sodium styrenesulfonate and in particular polystyrene-b-poly(sodium styrenesulfonate) or any amphiphilic copolymer prepared via any other polymerization technique.

The conventional emulsifier may be introduced into the polymerization medium in a proportion of from 0.1% to 10% by mass relative to the mass of monomer(s), and preferably in a proportion of from 0.5% to 8% by mass relative to the mass of monomer(s) to be polymerized.

In the process according to the invention, the conventional emulsifier is totally or partially replaced with stabilizing polymer molecules formed in situ. In one preferred embodiment of the invention, any nonionic component of the conventional emulsifier is totally replaced with the stabilizing polymer molecules formed in situ, which avoids the use of emulsifiers that are considered as harmful to the environment, such as polyethoxylated alkylphenols.

To perform the emulsion polymerization according to the invention, an ionizable water-soluble polymerization initiator is used. Examples that may be mentioned include the metal and ammoniacal salts of 4,4′-azobis(4-cyanopentanoic acid), and persulfate salts, such as sodium persulfate, potassium persulfate and ammonium persulfate. These initiators may be used alone, but they may also be combined with mineral or organic reducing agents such as sodium or potassium bisulfite and metasulfite, vitamin C, sodium or potassium hypophosphite, or sodium formaldehyde sulfoxylate. When the polymerization initiator is constituted by an oxidizing agent and a reducing agent, this is referred to as a redox pair; among the redox pairs that are useful for the invention, mention may be made of the hydrogen peroxide/ferrous ion salt pair, the (sodium, potassium or ammonium persulfate)/(sodium or potassium metabisulfite) pair or the (sodium, potassium or ammonium persulfate)/(sodium formaldehyde sulfoxylate) pair.

The polymerization initiator is added in a proportion of from 0.005% to 10% by mass relative to the mass of monomer(s), and preferably in a proportion of from 0.01% to 2.5% by mass relative to the mass of monomer(s) to be polymerized. It may be added in a single portion at the start of the polymerization or in several portions at different degrees of conversion of the monomers, or alternatively continuously over part or all of the polymerization time.

The ionizable polymerization initiator contributes, by the presence of its charge, toward stabilizing the latex.

The polymerizable monomer may be chosen from monomers containing a carbon-carbon double bond capable of polymerizing, such as vinyl, vinylidene, diene and olefinic, allylic, acrylic, methacrylic, etc. monomers.

The monomers under consideration may be a vinylaromatic monomer such as styrene or substituted styrenes, especially α-methylstyrene and sodium styrenesulfonate, a diene such as butadiene or isoprene, an acrylic monomer such as acrylic acid or salts thereof, alkyl, cycloalkyl or aryl acrylates such as methyl, ethyl, butyl, ethylhexyl or phenyl acrylate, hydroxyalkyl acrylates such as 2-hydroxyethyl acrylate, ether alkyl acrylates such as 2-methoxyethyl acrylate, alkoxy- or aryloxy-polyalkylene glycol acrylates such as methoxypolyethylene glycol acrylates, ethoxypolyethylene glycol acrylates, methoxypolypropylene glycol acrylates, methoxy-polyethylene glycol-polypropylene glycol acrylates or mixtures thereof, aminoalkyl acrylates such as 2-(dimethylamino)ethyl acrylate (DMAEA), acrylates of amine salts such as [2-(acryloyloxy)ethyl]trimethylammonium chloride or sulfate or [2-(acryloyloxy)ethyl]dimethylbenzylammonium chloride or sulfate, fluoro acrylates, silyl acrylates, phosphorus acrylates such as alkylene glycol phosphate acrylates, a methacrylic monomer, for instance methacrylic acid or salts thereof, alkyl, cycloalkyl, alkenyl or aryl methacrylates such as methyl, lauryl, cyclohexyl, allyl or phenyl methacrylate, hydroxyalkyl methacrylates such as 2-hydroxyethyl methacrylate or 2-hydroxypropyl methacrylate, ether alkyl methacrylates such as 2-ethoxyethyl methacrylate, alkoxy- or aryloxy-polyalkylene glycol methacrylates such as methoxypolyethylene glycol methacrylates, ethoxypolyethylene glycol methacrylates, methoxypolypropylene glycol methacrylates, methoxy-polyethylene glycol-polypropylene glycol methacrylates or mixtures thereof, aminoalkyl methacrylates such as 2-(dimethylamino)ethyl methacrylate (DMAEMA) or 2-(tert-butylamino)ethyl methacrylate (TBAEMA), methacrylates of amine salts such as [2-(methacryloyloxy)ethyl]-trimethylammonium chloride or sulfate or [2-(methacryloyloxy)ethyl]dimethylbenzylammonium chloride or sulfate, fluoro methacrylates such as 2,2,2-trifluoroethyl methacrylate, silyl methacrylates such as 3-methacryloyl-propyltrimethylsilane, phosphorus methacrylates such as alkylene glycol phosphate methacrylates, hydroxyethyl-imidazolidone methacrylate, hydroxyethylimidazolidinone methacrylate, 2-(2-oxo-1-imidazolidinyl)ethyl methacrylate, acrylonitrile, acrylamide or substituted acrylamides, 4-acryloylmorpholine, N-methylolacrylamide, acrylamidopropyl-trimethylammonium chloride (APTAC), acrylamidomethyl-propanesulfonic acid (AMPS) or salts thereof, methacrylamide or substituted methacrylamides, 2-methyl-N-[2-(2-oxoimidazolidinyl)ethyl]acrylamide, N-methylolmethacrylamide, methacrylamidopropyltrimethyl-ammonium chloride (MAPTAC), itaconic acid, maleic acid or salts thereof, maleic anhydride, alkyl or alkoxy or aryloxy-polyalkylene glycol maleates or hemimaleates, vinylpyridine, vinylpyrrolidinone, (alkoxy) poly(alkylene glycol) vinyl ethers or divinyl ethers, such as methoxy poly(ethylene glycol) vinyl ether, poly(ethylene glycol) divinyl ether, olefinic monomers such as ethylene, butene, hexene and 1-octene, and also fluoro olefinic monomers, and vinylidene monomers, such as vinylidene fluoride, used alone or as a mixture of at least two abovementioned monomers.

To perform the process according to the invention, conditions that are well known to those skilled in the art and frequently used in standard emulsion polymerization reactions in aqueous medium (or mini-emulsion or micro-emulsion reactions) are used. The process according to the invention may thus be readily adapted to the existing industrial manufacturing methods and processes by replacing only one starting material (conventional emulsifier) with another one ((meth)acrylic monomer of the invention). No preliminary step of preparing a stabilizing polymer is necessary.

The polymers obtained according to the process of the invention generally have high molecular masses; the number-average molecular mass is more particularly greater than 40 000 and preferably greater than 60 000, and/or the weight-average molecular mass is greater than 150 000.

The present invention also claims the use of a (meth)acrylic monomer of the type such as a polyethylene glycol or poly(ethylene-co-propylene) glycol or polyethylene glycol monoalkyl ether or poly(ethylene-co-propylene) glycol monoalkyl ether (meth)acrylic ester or amide, in which the alkyl group contains from 1 to 18 carbon atoms and preferably from 1 to 4 carbon atoms, for stabilizing the latices obtained by emulsion polymerization of at least one polymerizable monomer, in the presence of an ionizable polymerization initiator and optionally of a conventional emulsifier, characterized in that said monomer is introduced into the polymerization medium during at least one of the steps of the emulsion polymerization.

Another subject of the invention concerns the stabilized polymer latices obtained according to the process of the invention.

The term “stabilized latex” means a latex that has mechanical stability and chemical stability, i.e. that does not show any signs of flocculation under the test conditions described hereinbelow.

Within this latex, all the polymer particles have a mean diameter of less than 2 μm, generally between 0.04 μm and 1 μm.

These stabilized latices lead to materials or coatings whose properties are not impaired by surface graining-out of the stabilizers, as is generally the case with standard surfactants, due to the chemical attachment to the latex particles of the stabilizing polymer molecules.

In the examples that follow to illustrate the invention, without, however, limiting its scope, the following characterization techniques were used:
solids content of the latex: measured using a Mettler-Toledo thermobalance: HR73 Halogen Moisture Analyzer, heating at at least 150° C. to constant weight;
mean diameter of the latex particles: by light scattering (Malvern Lo-C machine);
mechanical stability of the latex: measured by shearing 150-200 ml of filtered latex (150 micron mesh) using a high-intensity mixer, for instance a Hamilton Beach machine at a speed of 12 000 rpm for 30 minutes. If the latex flocculates, it is filtered (100 micron mesh) and the flocculate is weighed;
chemical stability: checked by adding to 25 ml of filtered latex (150 micron mesh), with stirring for 15 minutes, 25 ml of a calcium chloride solution at 1% by weight, or at 10% by weight if the test at 1% does not give any flocculation.

The following materials were used:
potassium persulfate (Aldrich): ionizable polymerization initiator
Emulgator® K-30 (Bayer): conventional emulsifier based on a mixture of secondary alkanesulfonates
methoxy polyethylene glycol methacrylate (MPEGMA) with a number-average molecular mass, Mn, of 2080, free of ionizable impurities (Aldrich)
butyl acrylate (Arkema)
methyl methacrylate (Arkema)
methoxy polyethylene glycol methacrylate with a number-average molecular mass, Mn, of 2080, containing methacrylic acid as ionizable impurities: Norsocryl® N402 (Arkema).

### IMPLEMENTATION EXAMPLES

### Example 1

### Preparation of a Latex with Addition of a Methacrylic Monomer of Methoxy Polyethylene Glycol Methacrylate (MPEGMA) Type, Free of Ionizable Impurities

400 g of demineralized water are placed in a jacketed polymerization reactor allowing the circulation of a heat-exchange fluid for heating/cooling the system, a line for introducing a probe for measuring the temperature of the medium, a line for introducing nitrogen gas to flush out the oxygen, which inhibits the polymerization reaction, a stirrer connected to a motor for rotating at variable speed, two inlets for adding additives and a vapor outlet connected to a condensation/reflux system. Stirring is started at 150 revolutions per minute (rpm) and a flow of nitrogen is initiated via the nitrogen line so as to degas the reactor contents for at least 15 minutes with vigorous sparging. During this time, the following three mixtures are prepared in suitable containers:
a) a solution of 0.1 g of potassium persulfate in 1 g of water;
b) a monomer pre-emulsion obtained as follows: 180 g of demineralized water are first mixed with 12 g of a 40% solution of Emulgator® K-30, followed by addition to this solution of 27.6 g of a solution containing 50% by weight of MPEGMA (Aldrich), 141 g of butyl acrylate and 141 g of methyl methacrylate, the whole with stirring;
c) a solution of 1.2 g of potassium persulfate in 10.26 g of demineralized water.

The reactor is heated to the approximate target value of 75° C. When this temperature is reached, the nitrogen sparge is reduced to a bubbling rate and 6 g of the monomer pre-emulsion (b) prepared above are introduced into the reactor. The first initiator solution (a) is introduced, in turn, into the reactor and the reaction temperature is maintained at 75° C.±2° C., during the bleaching of the reaction medium (formation of the latex seed). The nominal heating temperature is then raised so as to reach a temperature of 81° C. in the reactor. When this temperature is reached, continuous metering, using suitable pumps or syringe pumps, of the rest of the monomer pre-emulsion and of the second initiator solution (c) prepared above is commenced. The pre-emulsion and the initiator (c) (additions) are metered into the reactor in parallel (without mixing them before introducing them into the reactor) for an addition time of 2 hours 30 minutes, while maintaining the reactor temperature at 81° C.±2° C. At the end of the addition, the lines are rinsed with 50 g of demineralized water, which enter the reactor, and the reactor temperature is raised to 85° C. and maintained at this value ±2° C. for a further 2 hours, before cooling and discharging the product.

The latex thus obtained has a solids content of 31.19% by weight.

The mean particle size was 359 nm.

The latex of this example did not show any flocculation, either during or after treatment in the shearing machine; its mechanical stability is thus considered as being excellent.

The latex of this example did not show any signs of flocculation, even with the 10% calcium chloride solution; its chemical stability is thus considered as being excellent.

### Example 2

### Preparation of a Latex with Addition of a Methacrylic Monomer of Methoxy Polyethylene Glycol Methacrylate Type Comprising Methacrylic Acid as Ionizable Impurity (Norsocryl® N402)

The process is performed as for Example 1, with the exception of the preparation of the pre-emulsion b), which is obtained as follows:
b) 180 g of demineralized water are first mixed with 12 g of a 40% solution of Emulgator® K-30, followed by addition to this solution of 29 g of Norsocryl N402 (Arkema), a solution containing 60% by weight of methoxy polyethylene glycol methacrylate, also containing about 2-4% by weight of methacrylic acid, 141 g of butyl acrylate, 146 g of methyl methacrylate, and 4 drops of an antifoam (Foamaster®), the whole with stirring.

The latex thus obtained has a solids content of 31.66% by weight.

The mean particle size was 376 nm.

The mechanical stability of the latex was excellent.

The latex of this example was subjected to the chemical stability test and showed no signs of flocculation, even with the 10% calcium chloride solution; its chemical stability is thus considered as being excellent.

### Example 3

### (Comparative): Preparation of a Latex without Addition of a Methacrylic Monomer of Methoxy Polyethylene Glycol Methacrylate Type

The latex of Examples 1 and 2 is prepared without adding methoxy polyethylene glycol methacrylate.

The process is performed as previously, with the exception of the preparation of the pre-emulsion b), which is obtained as follows:
b) a monomer pre-emulsion obtained as follows: 180 g of demineralized water are first mixed with 12 g of a 40% solution of Emulgator® K-30, followed by addition to this solution of 141 g of butyl acrylate, 141 g of methyl acrylate and 4 drops of antifoam (Foamaster®), the whole with stirring.

The latex thus obtained had a solids content of 32.00% by weight.

The mean particle size was 325 nm.

The mechanical stability of the latex proved to be poor, since the latex flocculated during the test. The chemical stability was very poor, since the latex flocculated on addition of the 10% calcium chloride solution, but also on addition of the 1% calcium chloride solution.

1. A process for preparing a stabilized latex, comprising emulsion of polymerizing at least one polymerizable monomer in the presence of a water-soluble polymerization initiator and of at least one emulsifier, wherein an ionizable water-soluble polymerization initiator is used and wherein during at least one of the emulsion polymerization steps the emulsifier is at least partially replaced with stabilizing polymer molecules formed in situ by introduction of a (meth)acrylic monomer selected from the group consisting of polyethylene glycol monoalkyl ether (meth)acrylic ester or amide, poly(ethylene-co-propylene) glycol monoalkyl ether (meth)acrylic ester or amide, polyethylene glycol monoalkyl ether monoalkyl ether (meth)acrylic ester or amide, and poly(ethylene-co-propylene) glycol monoalkyl ether (meth)acrylic ester or amide, wherein the alkyl group contains from 1 to 18 carbon atoms.

2. The process as claimed in claim 1, wherein the (meth)acrylic monomer is introduced into the polymerization medium in a proportion of from 0.05% to 30% by mass relative to the mass of monomer(s).

3. The process as claimed in claim 1, wherein the (meth)acrylic monomer has a number-average molecular mass of at least 750 daltons.

4. The process as claimed in claim 1, wherein the (meth)acrylic monomer contains a carboxylic acid in proportions that may be up to 20% by weight relative to the (meth)acrylic monomer.

5. The process as claimed in claim 1, wherein the (meth)acrylic monomer is a methoxy polyethylene glycol methacrylate, preferably with a number-average molecular mass ranging from 1000 to 6000 daltons.

6. The process as claimed in claim 1, wherein the (meth)acrylic monomer is introduced as a mixture with the monomer(s) to be polymerized.

7. The process as claimed in claim 1, wherein the ionizable polymerization initiator is selected from the group consisting of metal and ammoniacal salts of 4,4′-azobis(4-cyanopentanoic acid), persulfate salts, sodium persulfate, potassium persulfate and ammonium persulfate, which are used alone or in combination with mineral or organic reducing agents selected from the group consisting of sodium or potassium bisulfite and metasulfite, vitamin C, sodium or potassium hypophosphite, Of sodium formaldehyde sulfoxylate, redox pairs, the hydrogen peroxide/ferrous ion salt pair, the (sodium, potassium or ammonium persulfate)/(sodium or potassium metabisulfite) pair, and the (sodium, potassium or ammonium persulfate)/(sodium formaldehyde sulfoxylate) pair.

8. The process as claimed in claim 1, wherein the polymerizable monomer(s) is selected from the group consisting of a vinylaromatic monomer, styrene, substituted styrenes, α-methylstyrene sodium styrenesulfonate, a diene, butadiene, isoprene, an acrylic monomer, acrylic acid or salts thereof; alkyl, cycloalkyl or aryl acrylates; methyl, ethyl, butyl, ethylhexyl or phenyl acrylate, hydroxyalkyl acrylates; 2-hydroxyethyl acrylate, ether alkyl acrylates, 2-methoxyethyl acrylate, alkoxy- or aryloxy-polyalkylene glycol acrylates, methoxypolyethylene glycol acrylates, ethoxypolyethylene glycol acrylates, methoxypolypropylene glycol acrylates, methoxy-polyethylene glycol-polypropylene glycol acrylates aminoalkyl acrylates, 2-(dimethylamino)ethyl acrylate (DMAEA), acrylates of amine salts such as [2-(acryloyloxy)ethyl]trimethylammonium chloride or sulfate or [2-(acryloyloxy)-ethyl]dimethylbenzylammonium chloride or sulfate, fluoro acrylates, silyl acrylates, phosphorus acrylates, alkylene glycol phosphate acrylates, a methacrylic monomer, methacrylic acid or salts thereof; alkyl, cycloalkyl, alkenyl or aryl methacrylates; methyl, lauryl, cyclohexyl, allyl or phenyl methacrylate, hydroxyalkyl methacrylates, 2-hydroxyethyl methacrylate, 2-hydroxypropyl methacrylate, ether alkyl methacrylates, 2-ethoxyethyl methacrylate; alkoxy- or aryloxy-polyalkylene glycol methacrylates; methoxypolyethylene glycol methacrylates, ethoxypolyethylene glycol methacrylates, methoxypolypropylene glycol methacrylates, methoxy-polyethylene glycol-polypropylene glycol methacrylates, aminoalkyl methacrylates, 2-(dimethylamino)ethyl methacrylate (DMAEMA), 2-(tert-butylamino)ethyl methacrylate (TBAEMA), methacrylates of amine salts, [2-(methacryloyloxy)ethyl]-trimethylammonium chloride or sulfate, [2-(methacryloyloxy)ethyl]-dimethylbenzylammonium chloride or sulfate, fluoro methacrylates, 2,2,2-trifluoroethyl methacrylate, silyl methacrylates, 3-methacryloylpropyltrimethylsilane, phosphorus methacrylates, alkylene glycol phosphate methacrylates, hydroxyethyl-imidazolidone methacrylate, hydroxyethylimidazolidinone methacrylate, 2-(2-oxo-1-imidazolidinyl)ethyl methacrylate, acrylonitrile, acrylamide, substituted acrylamides, 4-acryloylmorpholine, N-methylolacrylamide, acrylamidopropyltrimethylammonium chloride (APTAC), acrylamidomethylpropanesulfonic acid (AMPS) or salts thereof, methacrylamide, substituted methacrylamides, 2-methyl-N-[2-(2-oxoimidazolidinyl)ethyl]acrylamide, N-methylolmethacrylamide, methacrylamidopropyltrimethylammonium chloride (MAPTAC), itaconic acid, maleic acid or salts thereof, maleic anhydride, alkyl or alkoxy or aryloxy-polyalkylene glycol maleates, alkyl or alkoxy or aryloxy-hemimaleates, vinylpyridine, vinylpyrrolidinone, (alkoxy) poly(alkylene glycol) vinyl ethers (alkoxy) poly(alkylene glycol) divinyl ethers, methoxy poly(ethylene glycol) vinyl ether, poly(ethylene glycol) divinyl ether, olefinic monomers, ethylene, butene, hexene and 1-octene, fluoro olefinic monomers, vinylidene monomers, vinylidene fluoride, and mixtures thereof.

9. (canceled)

10. A stabilized polymer latex obtained according to the process of claim 1.

11. The process of claim 1, wherein the alkyl group contains from 1 to 4 carbon atoms.

12. The process as claimed in claim 2, wherein the (meth)acrylic monomer is introduced into the polymerization medium in a proportion of from 0.1% to 10% by mass relative to the mass of monomer(s).

13. The process as claimed in claim 3 wherein the (meth)acrylic monomer has a number-average molecular mass of from 1,000 to 10,000 daltons.

14. The process as claimed in claim 4, wherein said carboxylic acid is (meth)acrylic acid.

15. The process as claimed in claim 5, wherein said (meth)acrylic monomer has a number-average molecular mass ranging from 1000 to 6000 daltons.
